(19) United States
(12) Patent Application Publication
(10) Pub. No.: US 2020/0059132 A1
(43) Pub. Date: Feb. 20, 2020

(54) Personal Electromechanical Hand Driven AC to DC Generator to Charge Mobile Devices

(71) Applicant: Mark H. Nuytkens, Franklin, MA (US)

(72) Inventor: Mark H. Nuytkens, Franklin, MA (US)

(21) Appl. No.: 16/542,965

(22) Filed: Aug. 16, 2019

Related U.S. Application Data
(60) Provisional application No. 62/764,921, filed on Aug. 16, 2018.

(51) Int. Cl. H02K 7/18; H02K 1/27; H02K 3/26; H02K 7/02; F03G 3/08

(52) U.S. Cl. CPC H02K 7/1853; H02K 1/2793; H02K 2203/03; H02K 7/02; F03G 3/08; H02K 3/26

(57) ABSTRACT

An efficient compact form factor for the hand powered mechanically driven flywheel electric generator for charging a smartphone or other personal device, in which the electric generator including a rotor and a stator, in which said rotor includes a plurality of alternating permanent magnetic fields arranged in a circular array such that a series of poles are established about the rotors circumference.

### PRIORITY

This patent application claims priority from provisional U.S. patent application No. 62/764,921, filed Aug. 16, 2018, entitled, “Personal electromechanical hand driven ac to dc generator to charge mobile devices,” and naming Mark Nuytkens as inventor, the disclosure of which is incorporated herein, in its entirety, by reference.

### FIELD OF THE INVENTION

Illustrative embodiments of the invention generally relate to generators and, more particularly, to hand powered electric generators. More specifically, illustrative embodiments of the present invention integrate the functionality of a miniature efficient hand powered mechanically driven personal electrical generator capable of charging mobile devices with the entertainment factor of a fidget toy having visual and auditory feedback.

### BACKGROUND OF THE INVENTION

Mobile devices run out of power at inopportune times at locations without power outlets creating panic for their user. To safeguard against power loss mobile device users often carry extra battery packs and/or a cadre of electrical chargers and adapters. This extra charging equipment is cumbersome, inconvenient and requires constant attention to finding sources of power outlets.

### SUMMARY OF VARIOUS EMBODIMENTS

A practical source of power available to the user at any time and any location is their own body. Tapping the power of the human body for low power needs such as charging a mobile device is very practical, however previous attempts to introduce products of this nature lacked a truly compact and portable form factor, high efficiency as to not exhaust the user and an entertaining mode of mechanical engagement. Illustrative embodiments are mountable to a variety of personal devices while not becoming an overly obtrusive accessory. Most mobile devices these days are planar in nature, due to the ergonomic constraints of easily sliding into a pocket. Compatible accessories preferably do not result in significant deviation of these constraints in this respect. Therefore, a low-profile form factor facilitating convenient mounting to a variety of personal mobile devices is useful.

Illustrative embodiments thus relate to a personal hand mechanically driven electrical generator capable of charging mobile devices. To achieve the above object, illustrative embodiments adopt the following technical solution:

An apparatus having a rotor, translation mechanism, stator, and power electronics. The rotor has a permanent magnet array configured such that flux lines travel through the stator parallel to the axis of rotation. The coil array of the stator is fixed in space and does not rotate with the rotor. The rotor has a sufficiently large moment of inertia to function as a flywheel at high speeds. The rotor includes a bearing which is mounted on a shaft protruding from a base plate allowing it to freely spin with little mechanical resistance.

The translation mechanism is a string, affixed by its ends to opposing outer edges of the rotor, held in tension by its midpoint, which is maintained in line with the central axis of the rotor. When wound into a double helix, maintaining the alignment of the midpoint, the translation mechanism is capable of converting an axial pull force of little displacement into rapid angular acceleration of the rotor. Mounted on the string is a pulling ring, which allows the user to precisely pull the string by its midpoint with force. By holding the device assembly in one hand and the pulling ring with the other hand, the user provides a fixed rotational reference for the stator and pulling ring with respect to the rotor's axis of rotation. The rotor can then be spun, causing the cords to twist around each other forming a double helix. When the cords have become sufficiently twisted, the user can then exert an axial force, to pull the ring away from the rotor. This force causes the rotor to rapidly accelerate as the twisted cords unwind. This rapid rotation generates an alternating voltage and current in the stator coils. If the user has imparted sufficient momentum to the rotor by the time the helix fully unwinds, the rotor will continue to rotate past the untwisted position, twisting the cords into a helix again, this time in the opposite direction.

Care preferably is taken to release most of the tension on the cords after the rotor has accelerated and the cords have unwound to allow them to fully wind back up in the opposite direction. With coordination the user can spin and unspin the rotor in a continuous and periodic manor. This allows power to be constantly generated in a sinusoidal fashion as the rotor accelerates and decelerates. Power electronics are used to optimally convert the generated power to an optimized charging source for a mobile device. The small amount of coordination required for operation, rapidly spinning movements, and whizzing sound of the strings make using the device highly entertaining.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is an exploded mechanical view of the assembly of the personal generator, according to the illustrative embodiments;

FIG. 2 is an assembled mechanical view of the personal generator, according to illustrative embodiments;

FIG. 3 is a cross section mechanical view of the personal generator with pull string, according to illustrative embodiments;

FIG. 4 is an expanded exploded mechanical view of the assembly of the personal generator, according to illustrative embodiments;

FIG. 5 are top, side, front, and perspective mechanical views of the assembled personal generator, according to illustrative embodiments;

FIG. 6 is a cross section mechanical view of the personal generator without pull string, according to illustrative embodiments;

FIG. 7 is a schematic and block diagram according to illustrative embodiments.

FIG. 8 is a generator and ac/dc architecture comprised of: i) an ac generator, ii) an ac/dc converter (rectifier, charge controller, and charge reservoir), and iii) a dc/dc converter (cycling Switching buck boost converter)

FIG. 9 is a schematic of a four coil stator diode bridge rectifier.

FIG. 10 is a schematic of a high efficiency buck boost converter.

### DESCRIPTION OF ILLUSTRATIVE EMBODIMENTS

The structure of a new personal hand driven mechanical to electrical generator capable of charging mobile devices will be explained in detail with reference to the accompanying drawings. The description and explanatory embodiments herein are merely used to set forth various embodiments, not to limit the scope of illustrative embodiments.

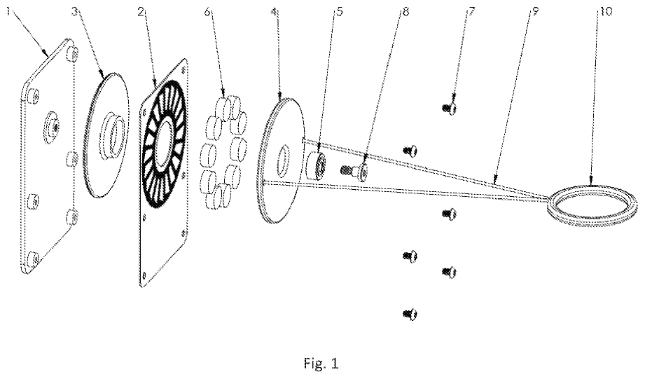

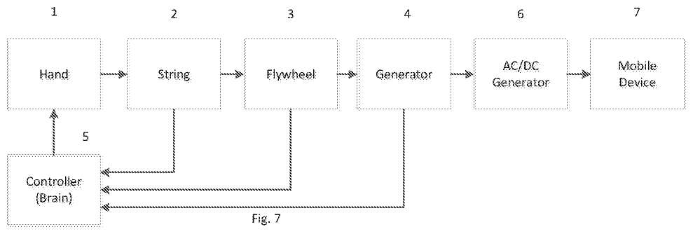

With reference to FIGS. 1-10, personal hand driven mechanical to electrical generator capable of charging mobile devices is disclosed. The generator comprises an assembly FIG. 1 including a Base plate 1.1, a Magnetic flux concentrator lower rotor 1.3, a Multi-layer coil stator ac/dc generator pcb 1.2, a plurality of Rare earth magnets 1.6, a Upper rotor and flywheel 1.4, a Ball bearing 1.5, that couples the flywheel rotor to the base plate via pinion 1.8, a Torsional string 1.9, that attaches to the outer circumference of the flywheel to Finger ring 1.10, a plurality of Screws 1.7 mounting with alignment to attach the stator to base plate.

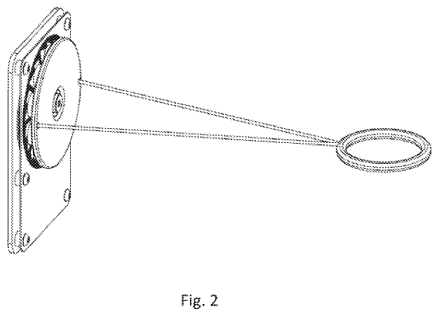

The assemble generator, FIG. 2, detail shows a compact planar form suitable for surface attachment to the mobile

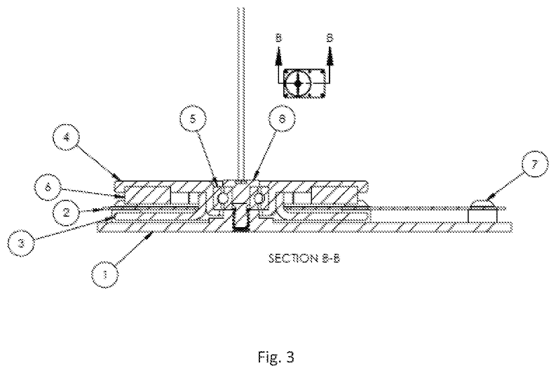

The generator assembly shown in cross section FIG. 3, including a Base plate 3.1, a Magnetic flux concentrator lower rotor 3.3, a Multi-layer coil stator ac/dc generator pcb 3.2, a plurality of Rare earth magnets 3.6, a Upper rotor and flywheel 1.4, a Ball bearing 3.5, that couples the flywheel rotor to the base plate via pinion 3.8, a plurality of Screws 3.7 mounting with alignment to attach the stator to base plate.

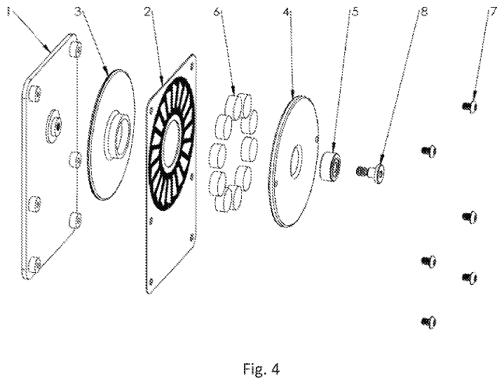

The generator detail comprises an assembly FIG. 4 including a Base plate 4.1, a Magnetic flux concentrator lower rotor 4.3, a Multi-layer coil stator ac/dc generator pcb 4.2, a plurality of Rare earth magnets 4.6, a Upper rotor and flywheel 4.4, a Ball bearing 4.5, that couples the flywheel rotor to the base plate via pinion 4.8, a plurality of Screws 4.7 mounting with alignment to attach the stator to base plate.

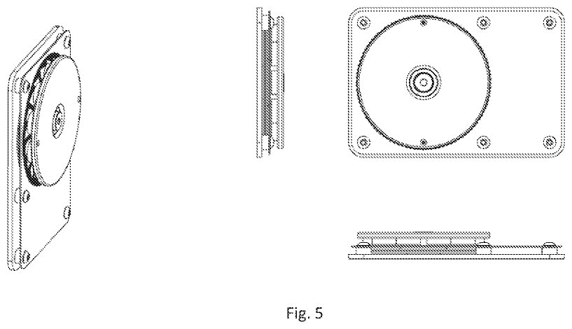

The assemble generator, FIG. 5, detail shows a compact planar form suitable for surface attachment to the mobile device. Top, side, front, and perspective mechanical views of the assembled personal generator are shown according to illustrative embodiments.

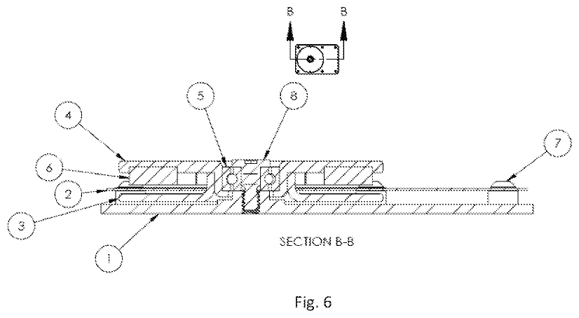

The generator assembly shown in cross section FIG. 6, including a Base plate 6.1, a Magnetic flux concentrator lower rotor 6.3, a Multi-layer coil stator ac/dc generator pcb 6.2, a plurality of Rare earth magnets 6.6, a Upper rotor and flywheel 6.4, a Ball bearing 6.5, that couples the flywheel rotor to the base plate via pinion 6.8, a plurality of Screws 6.7 mounting with alignment to attach the stator to base plate.

The hand powered mechanically driven personal electrical generator can be molded as a control system comprised of a Hand 7.1, a String 7.2, a Flywheel 7.3, a Generator 7.4, an AC/DC Converter 7.5, a Controller (Brain) 7.6, and a Mobile Device 7.7. The Hand 7.1 actuates the String 7.2, resulting in a torque on the Flywheel 7.3, causing rotation and inducing electrical voltage and current in the Generator 7.4. The brain as the Controller 7.6 senses tactile/torsional, auditory, and visual feedback from the String 7.2, Flywheel 7.3, and Generator 7.4. The String 7.2, produces an audible and visual indication of angular velocity and position of the generator within the generation cycle. The Flywheel 7.3, produces torsional feedback since its inertia keeps the generator spinning after the String 7.2 is unwound. The Generator 7.4 contributes to torsional resistance which manifests itself as tactile feedback and is proportional to angular velocity. The Generator 7.4 also exhibits visual feedback via an LED who's brightness is proportional to voltage. The voltage and current induced by the Generator is fed to an AC/DC Converter 7.5 that intern charges the Mobile Device 7.6.

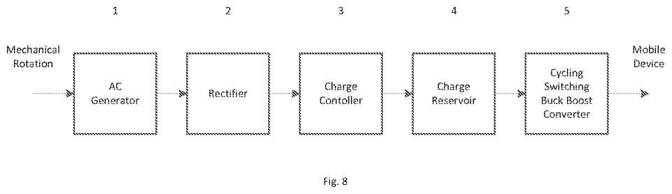

The generator and ac/dc architecture shown in FIG. 8, contain: i) an Ac generator 8.1, comprised of a free spinning rotor flywheel with a plurality of magnets, a fixed stator coils, ii) an ac/dc converter comprised of a Rectifier 8.2, a Charge controller 8.3, a Charge reservoir 8.4, and iii) a dc/dc converter comprised of a Cycling Switching buck boost converter 8.5. This cascaded power conversion architecture optimally captures sporadic pulsed ac bursts of power from the generator onto a charge reservoir which is then periodically converted to the mobile device by the switching buck boost converter. This cascaded mechanization accumulates energy of many cycles of generator rotations of 2 to 10 volts and 0.06 to 0.120 amps in order to provide a short burst of power of 5 volts and 0.5 amps necessary for the mobile device to charge. This power conversion is automatically controlled and regulated by the buck boost converter which senses charge reservoir voltage and operates with hysteresis allowing the charge reservoir to sufficiently charge each cycle before converting power to the mobile device.

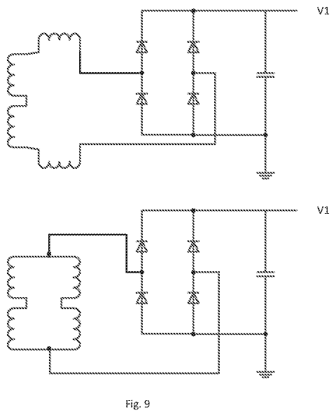

In more detail as shown in FIG. 9, the stator four coil generates an ac sinusoidal coil voltage and current induced by the cyclical spinning flywheel rotor feeds a four-diode bridge rectifier that produces a rectified waveform V1 that is filtered by a capacitor.

V1 is input to a charge controller that regulates and accumulates charge to optimally transfer power to a charge reservoir V2.

The charge controller employs a constant-current/constant-voltage charge algorithm with selectable preconditioning and charge termination. The constant voltage regulation set voltage is optimally matched to the charge reservoir (lithium battery, nickel hydride or super capacitor) charging requirements. The constant current value is set via a current mirror by a resistor. The controller limits the charge current based on temperature during high power or high ambient conditions. This thermal regulation optimizes the charge cycle time while maintaining device reliability. The preconditioning threshold, preconditioning current value, charge termination value and automatic recharge threshold are all optimized for the charge reservoir (lithium battery or super capacitor). The preconditioning value and charge termination value are set as a ratio or percentage of the programmed constant current value.

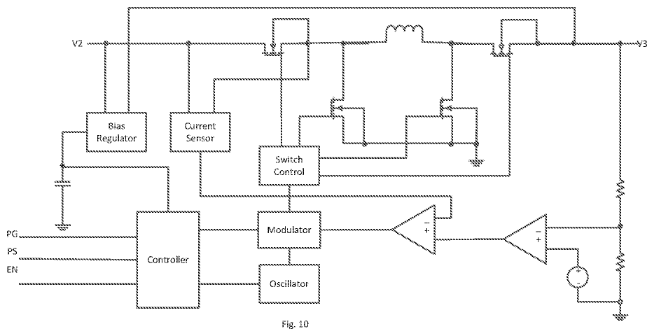

The charge reservoir (lithium battery or super capacitor) provides a power reservoir to the dc/dc switching buck boost controller. In more detail this architecture as shown in FIG. 10, combines a current mode, fixed frequency PWM architecture with burst mode operation to maintain high efficiency at light loads. Four N-channel MOSFETs are used to maintain synchronous power conversion at all possible operating conditions. This enables the device to keep high s efficiency over a wide input voltage and output power range. To regulate the output voltage at all possible input voltage conditions, the device automatically switches from buck operation to boost operation and back as required by the sensed configuration. The topology always uses one active switch, one rectifying switch, one switch on, and one switch held off. Therefore, it operates as a buck converter when the input voltage is higher than the output voltage, and as a boost converter when the input voltage is lower than the output voltage. There is no mode of operation in which all 4 switches are switching. The RMS current through the switches and the inductor is kept at a minimum, to minimize switching and conduction losses. For the remaining 2 switches, one is kept on and the other is kept off, thus causing no switching losses. Controlling the switches this way allows the converter to always keep high efficiency over the complete input voltage range. The device provides a seamless transition from buck to boost or from boost to buck operation.

The controller circuit of the device is based on an average current mode topology. The average inductor current is regulated by a fast current regulator loop which is controlled by a voltage control loop. The non-inverting input of the transconductance amplifier gmc can be assumed to be constant. The output of gmc defines the average inductor current. The inductor current is reconstructed by measuring the current through the high side buck MOSFET. This current corresponds exactly to the inductor current in boost mode. In buck mode, the current is measured during the on-time of the same MOSFET. During the off-time, the current is reconstructed internally starting from the peak value reached at the end of the on-time cycle. The average current is then compared to the desired value and the difference, or current error, is amplified and compared to the sawtooth ramp of either the Buck or the Boost. Depending on which of the two ramps is crossed by the signal, either the Buck MOSFETs or the Boost MOSFETs are activated. When the input voltage is close to the output voltage, one buck cycle is followed by a boost cycle. In this condition, not more than three cycle in a row of the same mode are allowed. This control method in the buck-boost region ensures a robust control and the highest efficiency.

Some innovations include:
1. A flywheel serves the purpose of converting the rotational acceleration of the rotor into rotational momentum as the double helix untwists. Once the string is fully untwisted the momentum of the flywheel then re-twists the string in the opposite direction as the rotor decelerates to a stop the cycle may then repeat in an oscillatory fashion.
2. The flywheel/string mechanism reaches sufficiently high angular velocities that no gearing is required.
3. The device of one or more of the above where the said mode of mechanical electricity generation involves the rotation of one element relative to another.
4. The device of one or more of the above where the said relative rotation is induced by the pulling of a string.
5. The device of one or more of the above where said string is affixed to the rotating element at both ends and the pulling point is at the midpoint of said string, such that when tension is applied to said string a triangular shape is created. While maintaining moderate tension on said string at its midpoint and fixing its midpoint from rotation about the axis of said rotating element the rotating element may be rotated, causing said string to be twisted forming a double helix. By increasing said tension to said midpoint of said string when said string is twisted in the form of said double helix, rapid mechanical rotation of said rotating element can be induced as said helix untwists.
5. A device of one or more of the above which is mountable to a smart/mobile phone or personal device.
6. A device of one or more of the above which provides auditory feedback through its operation. Said auditory feedback may be a whizzing sound due to components of the device rapidly moving through air.
7. A device of one or more of the above which, though its operation provides entertainment and satisfaction to its user through the coordinated motions of the user required for continuous operation.
8. The generator and ac/dc architecture that contain: i) an Ac generator comprised of a free spinning rotor flywheel with a plurality of magnets, a fixed stator coils, ii) an ac/dc converter comprised of a Rectifier, a Charge controller, a Charge reservoir, and iii) a dc/dc converter comprised of a Cycling Switching buck boost converter. This cascaded power conversion architecture optimally captures sporadic pulsed ac bursts of power from the generator onto a charge reservoir which is then periodically converted to the mobile device by the switching buck boost converter. This cascaded mechanization accumulates energy of many cycles of generator rotations of 2 to 10 volts and 0.06 to 0.120 amps in order provide a short burst of power of 5 volts and 0.5 amps necessary for the mobile device to charge. This power conversion is automatically controlled and regulated by the buck boost converter which senses charge reservoir voltage and operates with hysteresis allowing the charge reservoir to sufficiently charge each cycle before converting power to the mobile device.

The embodiments of the invention described above are intended to be merely exemplary; numerous variations and modifications will be apparent to those skilled in the art. Such variations and modifications are intended to be within the scope of illustrative embodiments as defined by any of the appended claims, which can be combined together in any set of permutations.

1. An efficient compact form factor for the hand powered mechanically driven flywheel electric generator for charging a smartphone or other personal device, the electric generator including a rotor and a stator, in which said rotor includes a plurality of alternating permanent magnetic fields arranged in a circular array such that a series of poles are established about the rotors circumference.

2. The device of claim 1 where the cross section of said rotor forms a C-shape core, flux lines of permanent magnets are concentrated and routed via material of high magnetic permittivity forming a “C” shape core with minimal gap maximizing the field strength across the gap.

3. The device of claim 1 in which said stator is composed of a plurality of conductors arranged in a pattern to convert changing magnetic fluxes due to the relative motion of said permanent magnetic fields to electric potential and current.

4. The device of claim 3 where the said plurality of patterned conductors are constructed on a multi-layer Printed Circuit Board (PCB)
